(19) United States
(12) Patent Application Publication
(10) Pub. No.: US 2006/0202427 A1
(43) Pub. Date: Sep. 14, 2006

(54) COMPUTER SKILLS CHALLENGE GAME METHODOLOGY

(76) Inventor: Hilbert M McDougal, Jacksonville, FL (US)

Correspondence Address: MARK YOUNG, P.A., 12086 FORT CAROLINE ROAD, UNIT 202, JACKSONVILLE, FL, 32225, US

(21) Appl. No.: 11/420,807

(22) Filed: May 30, 2006

Related U.S. Application Data
(63) Continuation-in-part of application No. 10/458,933, filed on Jun. 11, 2003.
(60) Provisional application No. 60/388,573, filed on Jun. 12, 2002.

(51) Int. Cl. A63F 13/00; A63F 9/24; A63F 9/18

(52) U.S. Cl. 273/430; 273/431; 463/40; 463/42

(57) ABSTRACT

A game allows contestants to access the Internet to answer questions, including solving problems. Contestants compete to quickly find answers to questions (and/or solutions to problems) using the Internet, with the first contestant to answer winning a prize or scoring points for that question. A contestant may be an individual or a plurality of individuals comprising a team. Contestants may be located in the same location or in geographically remote locations. After a determined number of questions, or a determined amount of time, the contestant with the most points wins the game and preferably a prize. Other contestants may receive consolation prizes. The winner may also advance to a timed bonus round for a grand prize. Ties between contestants may be resolved in a tiebreaker round.

### RELATED APPLICATION

This application is a continuation in part of and claims the benefit of priority of U.S. Nonprovisional application Ser. No. 10/458,933, filed Jun. 11, 2003, the entire contents of which are incorporated herein, which claims priority to U.S. Provisional Application 60/388,573, filed Jun. 12, 2002, the entire contents of which were incorporated therein.

### FIELD OF THE INVENTION

The present invention relates to a game show. In particular, the present invention relates to a game that requires contestants to obtain answers to questions from the Internet.

### BACKGROUND

Over the years many game shows have tested contestants' knowledge in many ways. For example, the popular quiz show, Jeopardy®., rewards a contestant for correct answers. On the Weakest Link® game show contestants vote to eliminate a fellow competitor they deem to be the weakest link (i.e., least knowledgeable). While such games have proven to be entertaining and stimulating, they have several shortcomings.

One shortcoming is that such games tend to cater to the strengths of highly educated and worldly individuals. Success often depends exclusively upon a contestant's knowledge of esoteric facts and arcane subjects. Such topics may be beyond the grasp of many individuals, making the game seem boring or annoying to them.

Another shortcoming is that such games neither challenge a contestant's research skills nor reward a contestant's resourcefulness. In day-to-day affairs, knowing how and where to find an answer are often as important as the answer itself. Yet conventional game shows require contestants to know or guess an answer.

One of the most valuable research tools of modern times, namely the Internet, has not, heretofore, been integrated into game shows. The Internet, particularly the World Wide Web, provides access to a wealth of information on countless topics contributed by people throughout the world. Unlike a conventional library in which all resources are identifiable and retrievable through a single catalogue, no one knows how many individual resources are accessible via the Internet. The number certainly runs into the many millions or billions and is growing at a rapid pace.

The Internet is a unique unprecedented research tool, with countless traps for the unwary and the capacity to accommodate countless concurrent users. Anyone with a small amount of technical skill and access to a host computer can publish on the Internet. Thus, some sites demonstrate an expert's knowledge, while others illustrate amateur efforts and ignorance, and others highlight nonsense and fetishes. Internet sites also change over time according to the commitment and inclination of the creator. Some may be updated daily, while others may be outdated, and others disappear.

Furthermore, as Internet sites may be accessed by many users concurrently, home viewers may readily play along and test their skills against contestants. These features of the Internet make it particularly attractive for use on a game show.

While other game systems and methodologies may utilize communications networks to transmit responses, none are configured to test a contestant's ability to find answers from locations on the Internet as determined by the contestant. Illustratively, Fennell, Jr. et al. (U.S. Pat. No. 5,695,400) teaches a networked multi-player game that reduces the effects of differences in network latency among terminals by communicating time-stamped game response signals. As another example, Berner et al. (U.S. Pat. No. 5,813,913) teaches a networked multi-player game whereby each participant player effectively competes only against players having a similar skill level as determined by a central computer system. Although the Fennell and Berner games contemplate network communication, neither of them teach or suggest finding answers on the Internet as an object of the game.

Other systems and methods have been devised to confirm a participant's visit to a determined Internet location. By way of example, Miles, et al., U.S. Pat. No. 6,102,406, requires users to visit pre-determined participating websites to find answers to questions. Answers to questions are included on the pre-determined participating websites. The system and methodology in Miles, et al., thus ensures that a user visited a website for advertising and or promotional purposes. However, it does not contemplate or enable participants to find answers anywhere on the Internet except the pre-determined specified locations. Thus, Miles, et al., is not configured to test a contestant's ability to find answers from any locations on the Internet as determined by the contestant.

A game is needed that tests a contestant's ability to find answers from any locations on the Internet, enables contestants to search for answers from any locations on the Internet, and facilitates locking in answers found at locations on the Internet. The invention is directed to overcoming one or more of the problems and solving one or more of the needs as set forth above.

### SUMMARY OF THE INVENTION

To overcome one or more of the problems as set forth above, in one aspect of the invention, a game methodology includes steps of determining one or more contestants, enabling Internet access for the one or more contestants, presenting a question to the one or more contestants, allowing the one or more contestants a determined amount of time to find and lock in an answer for that question from unspecified Internet locations, said answer being an answer found at an unspecified Internet location, determining when a contestant locks in an answer from an unspecified Internet location for that question, determining a location on the Internet from which the answer is found by the contestant, and scoring the one or more contestants according to performance in finding and locking in an answer to the question. Steps may be repeated for a plurality of questions and a plurality of rounds of play. To determine the winner of a round, the methodology may entail determining which contestant is first to lock in an answer from an unspecified Internet location and/or the time at which each of the one or more contestants locks in an answer from an unspecified Internet location. Bonus and tiebreaker rounds may be provided. Game play may be televised.

A system for playing a game according to principles of the invention includes a computer with Internet access for each of one or more contestants, means for presenting a question to the one or more contestants, means for locking in an answer from the Internet for that question, and means for determining which contestant locks in an answer first and if the each of one or more contestants exceed a determined amount of time to find and lock in the answer from the Internet for that question. Answers are locked in from unspecified Internet locations.

In another aspect of an exemplary implementation of a game according to principles of the invention, to answer a question, contestants access and search the Internet via the contestants' computer terminals. The first contestant to lock in an answer to the question is awarded points for that question. A contestant locks in an answer by performing an affirmative act, such as by selecting an icon, pressing a key combination, pressing a button, raising a hand, or stating something. Thus, in a preferred implementation, a means for locking in answer identifies the first contestant to perform the affirmative act within a determined time. By way of example and not limitation, a software enabled icon on a contestant's screen may trigger a screen capture, allowing the contestant to capture an Internet website displayed on the contestant's computer terminal, and/or saves a URL, and may also transmit to the server the captured/saved information along with the identity of the contestant to select the icon and a time stamp showing the time of selection. Alternatively, a software-enabled key combination pressed on a keyboard may provide the means for locking in answer. In another alternative, buttons adjacent to contestants' computer terminals may signal the identity of the first contestant to press the button. Thus, when an answer is locked in, a contestant who locked in the answer is identified, the location of the answer is saved or otherwise noted and the time (e.g., actual time or relative time) of locking in the answer is identified.

In another aspect of an exemplary implementation of a game according to principles of the invention, contestants are required to access the Internet and to find a correct answer from a location (e.g., website, webpage, file, document or any other object identifiable by a URL and/or other identifier) accessible on the Internet. Thus, even if a contestant knows an answer, the contestant must still find an Internet location that provides the correct answer. A game according to principles of the invention is not designed to test a contestant's knowledge of correct answers. Advantageously, this aspect of the invention ensures that a contestant's ability to quickly find answers on the Internet is tested.

In yet another aspect of an exemplary implementation of a game according to principles of the invention, the Internet locations include all objects (e.g., websites, webpages, files, documents or any other objects identifiable by URLs and/or other identifiers) that are accessible on the Internet and are not pre-specified (i.e., not determined by rules or hosts of the game). The objective of such an implementation is not to test a contestant's ability to find an answer on a determined webpage. Instead, contestants search for answers from the universe of Internet locations, i.e., locations that are not dictated or limited by the game host or another producer of the specific game. In a preferred implementation, all locations on the Internet may be accessed and are “fair game.” Thus, in a preferred embodiment, the universe of Internet locations comprises all locations accessible by a contestant on the Internet. Therefore, even if a contestant knows an answer, the contestant must still find an Internet location that provides the correct answer. Advantageously, this aspect of the invention ensures that a contestant's ability to quickly find answers on the Internet from the entire universe of Internet locations is tested.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a diagram that conceptually depicts an exemplary computer network for use in accordance with an implementation of the present invention; and

FIG. 2 is a flowchart that conceptually depicts steps of an exemplary game in accordance with an implementation of the present invention.

Those skilled in the art will appreciate that the invention is not limited to the exemplary embodiments depicted in the figures or the shapes, relative sizes, proportions or materials shown in the figures.

### DETAILED DESCRIPTION

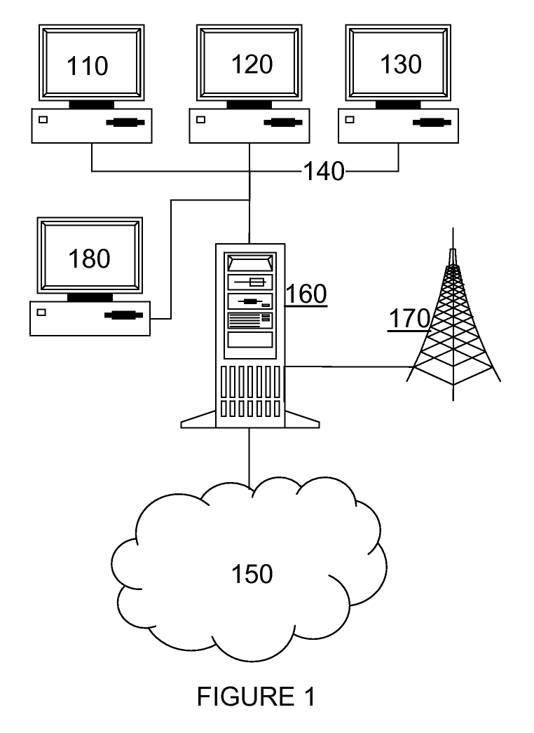

With reference to the drawings, wherein like numerals represent like features, an exemplary system and methodology and components thereof according to principles of the invention are conceptually shown. Referring first to FIG. 1, a system for playing a game in accordance with an exemplary embodiment of the present invention includes one or a plurality of terminals 110-130 communicatively connected to one or more networks 140, including the Internet 150. Each terminal is preferably comprised of a computer system, preferably having a bus for communicating information, a central processing unit (CPU), a read only memory (ROM), a random access memory (RAM), a mass storage device, a display device and an input device.

The storage device may include a hard disk, CD-ROM drive, DVD drive, tape drive, memory (e.g., RAM, ROM, Compact Flash RAM, PCMCIA RAM) and/or other storage equipment. The input device may include a keyboard, touch sensitive screen, a pointing device (e.g., a computer mouse, touch pad or joystick) and the like. Software such as an operating system and Internet browser are preferably stored on and executable on the terminal. These elements are typically included in many computer systems known in the art, and the aforementioned terminal is intended to represent a broad category of computer systems capable of supporting Internet access and research in accordance with the present invention. Of course, the terminals may include fewer, different and/or additional elements, provided each is capable of performing determined functions in accordance with the present invention.

In a preferred implementation, an exemplary game in accordance with the present invention is played as a televised game show. A host presents questions to a plurality of contestants. Each contestant may be an individual or a plurality of individuals (e.g., a team). The contestants may be located in the same facility (e.g., a television studio) or in separate facilities (e.g., studios in different cities). The contestants compete for the best score and/or prizes based upon their performance, as discussed more fully below.

Those skilled in the art will appreciate that versions of the game that are not televised game shows are readily feasible and come within the scope of the present invention. While a televised game show is a preferred implementation, the present invention may be implemented, for example, as a play-at-home version or a play at a club (e.g., at an Internet cafe) version without departing from the scope of the present invention.

In an alternative implementation, a single contestant may play the game. Again, the contestant may be an individual or a plurality of individuals. Instead of competing head-to-head with other contestants, the playing contestant may compete against time, a prior contestant's score or a determined minimum score. For example, a determined amount of time may be given, or the playing contestant may perform an act (e.g., roll dice, spin a wheel or the like) to determine a minimum score or an amount of time allowed to correctly answer a question.

To play the game, each contestant is provided access to a computer terminal having Internet access. In a preferred implementation, as discussed above, each contestant uses a comparably equipped computer with comparable Internet access capability. By way of example and not limitation, contestants in a studio may have access to a computer equipped with a state of the art processor, ample random access memory (RAM), an effective operating system, a stable Internet browser, adequate hard drive capacity for surfing the Internet, a keyboard, a mouse, a display, and an network interface card with access to a equipment such as a router having a high-speed communications link to the Internet. However, the present invention is not limited to any specific computer, operating system, Internet browser software, input devices, display device or Internet network connectivity.

In another implementation, contestants may be given an opportunity to supply or configure the computers they use to play the game. For example, contestants may be required to supply their own computer. Guidelines may be established regarding the performance, size and compatibility of each computer. Limits may be established regarding the central processing unit, random access memory, hard disk, operating system, Internet browser software, input devices, display device and/or network connectivity. In this version of the game, a contestant's performance will depend, at least in part, upon the integrity and performance of the contestant's computer, much like NASCAR® drivers depend upon their cars and Battlebots® contestants depend upon their robots. Advantageously, the resourcefulness and creativity of contestants adds an exciting dimension to the game. Before each game, contestants may be given an opportunity to describe their computers.

In a preferred televised version of the game, a television broadcast unit 170 outputs a television signal, which can be received by viewers via their television receivers in a conventional manner. Such reception may be via satellite dish, cable television, UHF/VHF roof-top antenna, or the like. The system server may obtain information from contestants' terminals. The broadcast unit may obtain such information from a server 160 and broadcast all or portions of such information for viewing by viewers.

In a preferred televised version of a game in accordance with the present invention, a host presents questions for contestants to answer. The host is preferably equipped with a terminal 180 for receiving and reading questions. In a play at home version of the game, a non-contestant may be the host. Alternatively, contestants may take turns being the host or the contestant who wins a round may be the host for the next question. In another alternative, questions may appear on a screen visible to the contestants and/or on each contestants' computer terminal. Thus, the means for presenting questions may include a host and/or one or more displays, and/or one or more tangible media of visual expression (e.g., cards).

Questions may be randomly selected from a plurality of pre-determined questions. Alternatively, pre-determined questions may be presented in a pre-determined order. The host may read each question to the contestants, such as from an index card or a display 180. By way of example, a question may appear on a large screen that is visible to a studio audience and communicatively connected to the television broadcast unit. In a play at home version, questions may be provided on printed cards, via the Internet or stored on computer-readable media (e.g., CD-ROMs).

Contestants have a determined amount of time to answer a question. The time is measured from the moment a question is read by the host, displayed to the contestants or a subsequent starting signal (e.g., a green light) has been activated. A timer is preferably provided. An alarm may sound if a determined amount of time is reached and no answer has been locked in. If a contestant does not lock in a correct answer within a determined amount of time, then no points are awarded for that question. In one embodiment, the timer may disable the means for locking in an answer once the alarm has been triggered, until the timer is reset for a new round. Thus, the timer provides a means for determining if the contestants exceed a determined amount of time to find and lock in the answer from the Internet for a question.

To answer a question, contestants access and search the Internet via the contestants' computer terminals. The first contestant to lock in an answer to the question is awarded points for that question. A contestant locks in an answer by performing an affirmative act, such as by selecting an icon, pressing a key combination, pressing a button, raising a hand, or stating something. Thus, in a preferred implementation, a means for locking in answer identifies the first contestant to perform the affirmative act within a determined time. By way of example and not limitation, a software enabled icon on a contestant's screen may trigger a screen capture, allowing the contestant to capture an Internet website displayed on the contestant's computer terminal, and/or saves a URL, and may also transmit to the server the captured/saved information along with the identity of the contestant to select the icon and a time stamp showing the time of selection. Alternatively, a software-enabled key combination pressed on a keyboard may provide the means for locking in answer. In another alternative, buttons adjacent to contestants' computer terminals may signal the identity of the first contestant to press the button. Thus, when an answer is locked in, a contestant who locked in the answer is identified, the location of the answer is saved or otherwise noted and the time (e.g., actual time or relative time) of locking in the answer is identified.

Means for scoring the one or more contestants according to performance in finding and locking in an answer to the question. By way of example, and not limitation the means for scoring may include a software-enabled system of awarding points corresponding to monetary amounts (e.g., $5,000) for locking in an answer to a question first. If a contestant locks in an incorrect answer, the contestant may be penalized by deducting a determined amount of points, even if the total points becomes negative for that contestant. The total score for each contestant may be displayed.

Each question and answer is a round of play. At the end of a determined number of rounds, the contestant with the most points wins. Other contestants may receive consolation prizes, for example equally or with prizes valued according to a contestant's place (e.g., 2nd place, 3rd place and so on). Ties may be broken in tiebreaker rounds. The winner may be awarded a prize and have an opportunity to play a bonus round (e.g., an additional timed round) for a grand prize.

Importantly, the game is designed to test a contestant's resourcefulness in finding answers. Answers to questions are preferably unlikely to be immediately known to the contestants. In a preferred implementation of a game in accordance with the present invention, contestants are required to access the Internet and to find a correct answer from a location (e.g., website, webpage, file, document or any other object identifiable by a URL and/or other identifier) accessible on the Internet. Thus, even if a contestant knows an answer, the contestant must still find an Internet location that provides the correct answer. A game according to principles of the invention is not designed to test a contestant's knowledge of correct answers. Advantageously, this aspect of the invention ensures that a contestant's ability to quickly find answers on the Internet is tested.

As used herein, the term question refers to conventional questions (e.g., What is the title of the last chapter of Charles Dickens' A Tale of Two Cities? or, in what year was Sir Isaac Newton's book known as the Principia first published?), as well as to requests and problems. By way of example, a request may ask a contestant to show or play one or more things (e.g., show us a picture of Henri Rousseau's painting Sleeping Gypsy). A question may also require a contestant to solve a problem (e.g., what is the straight-line distance from New York, N.Y. to New Orleans, La.? or what is the weight in pounds of one cubic foot of titanium?) such as by referring to a map, table or other reference material on one or more Internet websites. Advantageously, the present invention accommodates a wide range of question types, including those requiring a contestant to find an image, audio clip or other multimedia accessible on the Internet.

Another important aspect of a game according to principles of the invention is that the Internet locations (e.g., websites, webpages, files, documents or any other objects identifiable by URLs and/or other identifiers) from which contestants find answers are not pre-specified. Such Internet locations, which are referred to herein as “unspecified Internet locations,” may include any Internet locations determined by contestants from the universe of Internet locations accessible by a contestant, not specific locations defined by a game host, some other party or rules of the game. The objective is not to test a contestant's ability to find an answer on a determined webpage. Instead, in a preferred implementation, contestants search for answers from the entire universe of accessible Internet locations, i.e., locations that are not dictated or limited by the game host or another producer of the specific game. While accessibility to inappropriate (e.g., pornographic) websites may be limited or prevented by filtering or other blocking technologies in certain implementations of a game according to principles of the invention, the universe of Internet locations comprises all locations accessible by a contestant and the answers are locked in from Internet locations determined by contestants, not specific locations defined by a game host, some other party or rules of the game. In a particular preferred implementation, all locations on the Internet may be accessed and are “fair game.” Thus, in such a preferred embodiment, the universe of Internet locations comprises all locations accessible by a contestant on the Internet. Therefore, even if a contestant knows an answer, the contestant must still find an Internet location that provides the correct answer. Advantageously, this aspect of the invention ensures that a contestant's ability to quickly find answers on the Internet from the entire universe of Internet locations is tested.

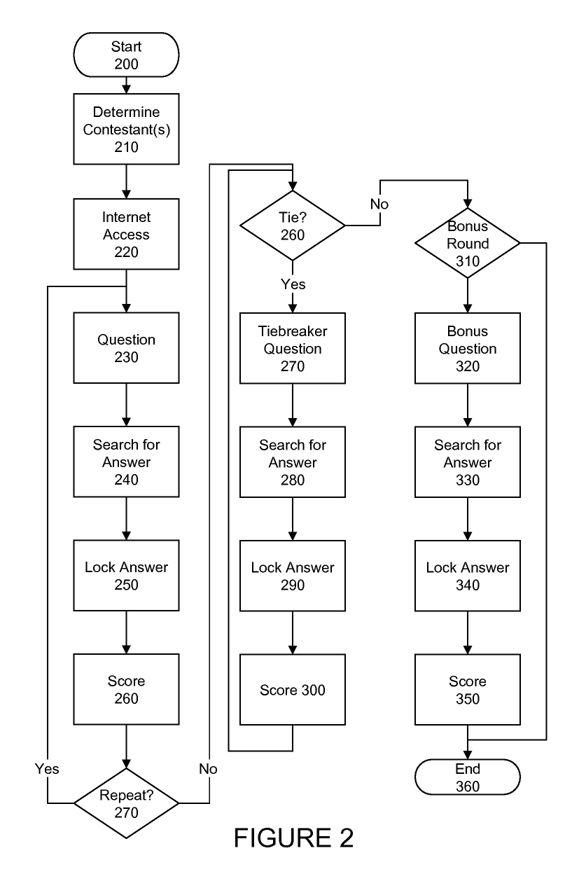

Referring now to FIG. 2, a flowchart of an exemplary game methodology in accordance with the present invention is conceptually shown. The methodology entails selecting or determining contestants 210. The selection may be accomplished by random drawing from a pool of candidates, application and try-outs, or any other method for selecting game contestants.

Next, Internet access is enabled for each contestant 220. Thus, each contestant may surf the Internet, including the World Wide Web, to find answers to questions.

Next, a question is presented to the contestants 230. The contestants then have a determined amount of time to lock in an answer 240. Scoring entails adding or deducting points 250. The first contestant to lock-in a correct answer wins points for that question. A contestant who locks in a wrong answer loses points for that question. The steps of question, answer and scoring 230-250 repeat until the end of the game play. At the end of game play, any tie scores 260 are broken in a tie-breaker round 270-300 among the tied contestants, with a tie-breaker question 270, searching for an answer 280, locking an answer 290 and scoring 300. The tie-breaker round 270-300 may repeat 260 until the tie is broken.

After the end of game play, the contestant with the highest score may have an opportunity to play a bonus round 310, with a bonus question 320, searching for an answer 330, locking an answer 3400 and scoring 350. Optionally, within a determined amount of time, the contestant may lock-in a correct answer to win bonus points for that question, lock in a wrong answer and lose points for that question, or not lock in an answer, in which case the contestant may either lose points or not lose points. The exemplary game ends 360 after completing all rounds of play.

The foregoing detailed description of particular preferred implementations of the invention, which should be read in conjunction with the accompanying drawings, is not intended to limit the enumerated claims, but to serve as particular examples of the invention. Those skilled in the art should appreciate that they can readily use the concepts and specific implementations disclosed as bases for modifying or designing other methods and systems for carrying out the same purposes of the present invention. Those skilled in the art should also realize that such equivalent methods and systems do not depart from the spirit and scope of the invention as claimed.

While an exemplary embodiment of the invention has been described, it should be apparent that modifications and variations thereto are possible, all of which fall within the true spirit and scope of the invention. With respect to the above description then, it is to be realized that the optimum relationships for the components of the invention and steps of the process, including variations in form, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A game methodology comprising steps of:
determining one or more contestants;
enabling Internet access for the one or more contestants;
presenting a question to the one or more contestants;
allowing the one or more contestants a determined amount of time to find and lock in an answer for that question from unspecified Internet locations, said answer being an answer found at an unspecified Internet location;
determining when a contestant locks in an answer from an unspecified Internet location for that question;
determining a location on the Internet from which the answer is found by the contestant; and
scoring the one or more contestants according to performance in finding and locking in an answer to the question.

2. A game methodology according to claim 1 wherein the steps of
presenting a question to the one or more contestants;
allowing the one or more contestants a determined amount of time to find and lock in an answer for that question from unspecified Internet locations, said answer being an answer found at an unspecified Internet location;
determining when a contestant locks in an answer from an unspecified Internet location for that question;
determining a location on the Internet from which the answer is found by the contestant; and
scoring the one or more contestants according to performance in finding and locking in an answer to the question;
are repeated for a plurality of questions.

3. A game methodology according to claim 1 wherein the step of determining when a contestant locks in an answer from an unspecified Internet location for that question includes determining which of the one or more contestants is first to lock in an answer from an unspecified Internet location.

4. A game methodology according to claim 1 wherein the step of determining when a contestant locks in an answer from an unspecified Internet location for that question includes determining a time at which each of the one or more contestants locks in an answer from an unspecified Internet location.

5. A game methodology according to claim 1 further comprising steps of presenting a bonus question to one of the one or more contestants; allowing the one of the one or more contestants a determined amount of time to find and lock in an answer from the Internet for that bonus question; and scoring the one of the one or more contestants according to performance in finding and locking in an answer to the question.

6. A game methodology according to claim 2 further comprising steps of presenting a bonus question to one of the one or more contestants; allowing the one of the one or more contestants a determined amount of time to find and lock in an answer from the Internet for that bonus question; and scoring the one of the one or more contestants according to performance in finding and locking in an answer to the question.

7. A game methodology according to claim 1 further comprising the step of televising the one or more contestants.

8. A game methodology according to claim 2 further comprising the step of televising the one or more contestants.

9. A game methodology according to claim 4 further comprising the step of televising the one or more contestants.

10. A system for playing a game comprising a computer with Internet access for each of one or more contestants; means for presenting a question to the one or more contestants; means for locking in an answer from an unspecified Internet location for that question, and means for determining when a contestant locks in an answer from an unspecified Internet location for that question.

11. A system for playing a game according to claim 10, wherein the means for determining when a contestant locks in an answer from an unspecified Internet location includes determining a time when each contestant locks in an answer.

12. A game methodology comprising steps of:
determining one or more contestants;
enabling Internet access for the one or more contestants;
presenting a question to the one or more contestants;
allowing the one or more contestants a determined amount of time to find and lock in an answer for that question from unspecified Internet locations, said answer being an answer found at an unspecified Internet location;
determining which contestant is the first contestant to lock in an answer;
determining a location on the Internet from which the answer is found by the contestant; and
scoring the one or more contestants according to relative performance in finding and locking in an answer to the question.

13. A game methodology according to claim 12 wherein the steps of
presenting a question to the one or more contestants;
allowing the one or more contestants a determined amount of time to find and lock in an answer for that question from unspecified Internet locations, said answer being an answer found at an unspecified Internet location;
determining which contestant is the first contestant to lock in an answer;
determining a location on the Internet from which the answer is found by the contestant; and
scoring the one or more contestants according to relative performance in finding and locking in an answer to the question;
are repeated for a plurality of questions.

14. A game methodology according to claim 12 wherein the step of determining when a contestant locks in an answer from an unspecified Internet location for that question includes determining a time at which each of the one or more contestants locks in an answer from an unspecified Internet location.

15. A game methodology according to claim 12 further comprising steps of presenting a bonus question to one of the one or more contestants; allowing the one of the one or more contestants a determined amount of time to find and lock in an answer from the Internet for that bonus question; and scoring the one of the one or more contestants according to performance in finding and locking in an answer to the question.

16. A game methodology according to claim 13 further comprising steps of presenting a bonus question to one of the one or more contestants; allowing the one of the one or more contestants a determined amount of time to find and lock in an answer from the Internet for that bonus question; and scoring the one of the one or more contestants according to performance in finding and locking in an answer to the question.

17. A game methodology according to claim 12 further comprising the step of televising the one or more contestants.

18. A game methodology according to claim 12 further comprising the step of televising the one or more contestants.

19. A game methodology according to claim 15 further comprising the step of televising the one or more contestants.

20. A game methodology according to claim 12 wherein the unspecified Internet locations include any and all objects accessible on the Internet.
